(19) United States
(12) Patent Application Publication
(10) Pub. No.: US 2017/0311754 A1
(43) Pub. Date: Nov. 2, 2017

(54) METHOD AND APPARATUS FOR PROVIDING A BATTERY OPERATED ROTISSERIE

(71) Applicants: Ronald Adams, Mercer, PA (US); Richard Francis Woge, Hermitage, PA (US)

(72) Inventors: Ronald Adams, Mercer, PA (US); Richard Francis Woge, Hermitage, PA (US)

(21) Appl. No.: 15/378,226

(22) Filed: Dec. 14, 2016

Related U.S. Application Data
(60) Provisional application No. 62/330,647, filed on May 2, 2016.

(51) Int. Cl. A47J 37/04; A47J 43/18

(52) U.S. Cl. CPC A47J 37/041; A47J 43/18

(57) ABSTRACT

An apparatus for holding and rotating food, the apparatus comprising a fork, an extendible arm configured to removably attach the fork, a motor configured to be coupled to the fork to rotate the fork and a height adjustable support for the arm. The fork includes prongs that are U shaped, wherein the distal ends of the prongs are bent backward and include a wave or zig-zag portions.

### FIELD

This disclosure is in the field of cookery.

### BACKGROUND

When cooking outdoors, such as over an open fire,, it is common to turn the food manually. For instance, when cooking a hot dog on a stick, the stick must be turned manually to ensure the meat is cooked evenly. This evenness is hard to achieve because it is difficult to continuously rotate a stick manually and is usually rotated step-wise. Further, the proximity of a hand to an open fire presents a possible danger for burns. Prior art devices generally have a manual rotation method, such as turning a crank like a fishing rod without convenient push button or battery operation.

U.S. Patent Application No. US 2006/0076789 A1 to Herbert, discusses a cook out food roaster. The rotisserie device may be turned at a predetermined speed and includes a coupler for attaching extendable cooking attachments to the device.

U.S. Pat. No. 6,754,966 B2 to Holzer discusses a hot dog roaster with adjustable prongs. The prongs may be folded back to prevent injury or to prevent damage to other objects. When cooking, the food may be manually rotated in a mostly continuous way basis or alternatively, the food may be rotated intermittently when cooking.

U.S. Pat. No. 6,701,827 B1 to Longbrake, discusses a manual hot dog roaster for cooking outdoors. The apparatus is designed to help the user cook a hot dog more evenly. When cooking, the food may be manually rotated in a mostly continuous way basis or alternatively, the food may be rotated intermittently.

### SUMMARY

In the view of the foregoing disadvantages inherent in the known types of rotisserie devices for heating food, such as hot dogs, that is now present in the prior art, the present disclosure provides an improved and automated rotisserie stick (hotdog stick) that rotates and evenly cooks food. As such, the general purpose of the present disclosure, which will be described subsequently in greater detail, is to provide a new and improved battery operated rotisserie stick.

The inventive aspect described in the specification can be embodied in an apparatus for holding and rotating food, such as a hot dog. The apparatus may further include an extendible arm configured to removably attach a fork or a like device for piercing and holding food. The further inventive aspects can be embodied in a motor configured to be coupled to the fork to rotate the fork. Thus, the motorized device may rotate the food over an open fire while the user simply holds the device.

The other inventive aspects can be embodied in a system for a height adjustable support for the extendible arm. Thus, a user may adjust the distance to an open fire for holding and rotating food. Yet other inventive aspects cart be embodied in the system for holding and rotating food wherein the prongs of the fork are U shaped, wherein distal ends of the prongs may be bent backward and include wave or zig-zag portion. The further inventive aspects can be embodied in the apparatus for holding and rotating food, wherein a lamp is attached to the arm and is configured to shine light, such as to shine light on the prongs. This may help make the food visible in darkened outdoor conditions. The other inventive aspects may be embodied in wherein the rotation of the fork or prong is automated and may be remotely controlled by a user. Such automation may include a battery power source.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attuned by its uses, reference should be made to the accompanying drawings and descriptive matter in which there are illustrated preferred embodiments of the disclosure.

### BRIEF DESCRIPTION OF THE DRAWINGS

The example embodiments of the inventive concept will be better understood from the following brief description taken in conjunction with the accompanying drawings. The drawing. FIGS. 1-6 represent non-limiting, example embodiments.

FIG. 1 shows a handle for an automatic food rotisserie, in accordance with an example embodiment.

FIG. 2 shows a set of prongs and securing mechanism for an automatic food rotisserie, in accordance with an example embodiment.

FIG. 3 shows a rod coupler configured to couple to a handle of an automatic food rotisserie, in accordance with an example embodiment.

FIG. 4 shows a rod coupler connected to a plastic handle, in accordance with an example embodiment.

FIG. 5 shows a rotisserie cooking apparatus, in accordance with an example embodiment.

FIG. 6 shows height adjustable rotisserie cooking apparatus, in accordance with an example embodiment.

### DETAILED DESCRIPTION

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes inns be made without departing from the spirit and scope of the present inventive concept. The following description is, therefore, not to be taken in a limiting sense.

Example embodiments of the inventive concepts may be embodied in many different forms and should not be construed as being limited to the embodiments set forth herein; rather, these embodiments are provided so that this disclosure will be thorough and complete, and will convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The current disclosure is battery operated to allow the stick to rotate continuously and uniformly for even cooking, and thus obviates the need to manually turn the hotdog stick.

In one embodiment, the automatic rotisserie allows even cooking over an open fire without the need for manual intervention. In another embodiment, the automatic rotisserie includes at least one prong with a shape and/or geometry to ensure the food, such as a hotdog is secure and will not rotate with respect to the prong. Such a geometry may include a spiral, corkscrew, zigzags or wave shape to ensure the food is secure through 360 degrees of rotation.

In one embodiment, the automated rotisserie is batters operated and thus turns the food without using a manual mechanism. In one embodiment, the automated rotisserie allows the user to prop up the stick and allow the food to cook automatically.

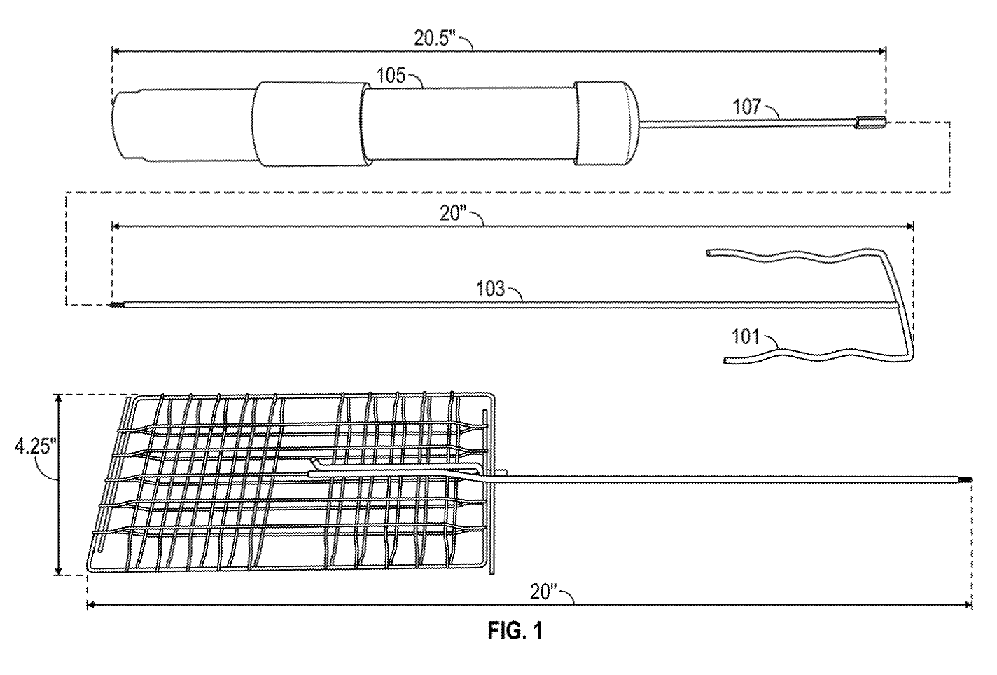

FIG. 1 shows a diagram that that includes the components for the automatic rotisserie that may include: ⅛″ thick stainless reverse skewers (101), 3/16″ thick stainless rod (103) spot welded to the skewers, a 1.5″ PVC cap with a 3/16″ hole to accept the rod (103), a 12 inch long and 1.5 inch diameter PVC pipe (105) with a rod support 8 inches from cap to accept the rod, and a 1.5″ PVC coupling. The apparatus may also include a flexible coupling (107) to connect the rod to a motor, and a 5 inch long 1.5 inch diameter PVC pipe with flexible mounted motor battery compartment and switch mechanism.

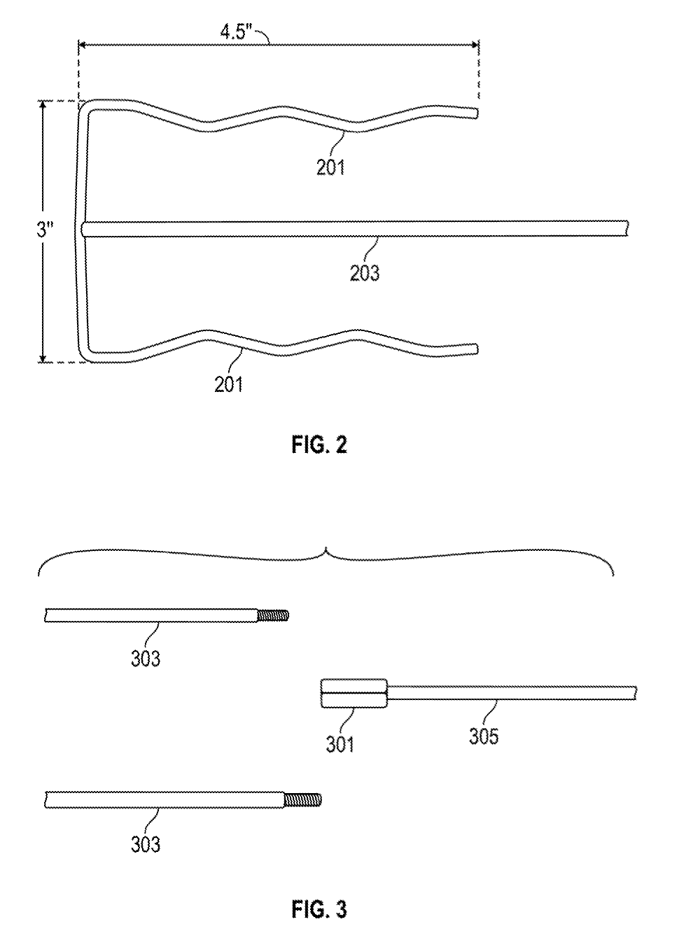

FIG. 2 shows a stainless steel rod with reverse skewers or prongs. In one embodiment, the skewers (201) may include a wave (as shown), spiral, corkscrew, curve, or other like geometer that secures the food while the food is rotated and cooked. Thus, the food will not rotate on the skewer and cook unevenly. The skewers may be bent in a U and attached to a stainless steel rod (203).

FIG. 3 shows a rod coupler for providing a handle of an automatic food rotisserie, in accordance with an example embodiment. In one embodiment, the rod coupler (301) is matched with a threaded component of a stainless steel rod (303) of skewers. In one embodiment, the rod coupler piece (305) will connect through a PVC pipe to a motor, which will power the rotation of the rotisserie apparatus. The motor may be controlled with one or more automatic controls and may be battery powered. In an example embodiment, the rotation of the rotisserie may be remotely controlled.

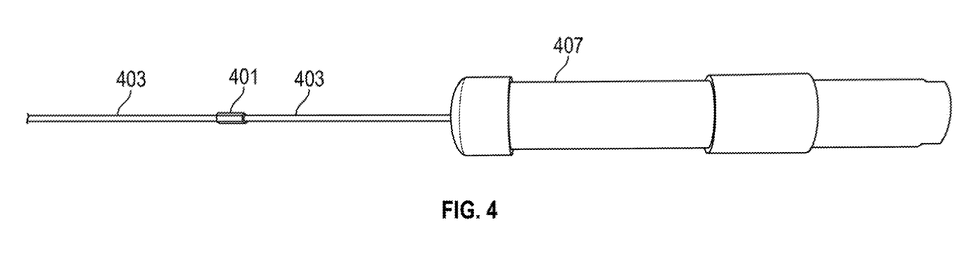

FIG. 4 shows an illustration of a rod coupler connected to a plastic handle, in accordance with an example embodiment. In one embodiment, the rod coupler (401) is connected with a threaded component of a stainless steel rod of skewers (403). In one embodiment, the rod coupler piece (405) is passed through the PVC pipe (407) to connect with a motor, which will power the rotation of the rotisserie apparatus. The motor may be controlled with one or mote automatic controls and may be battery powered.

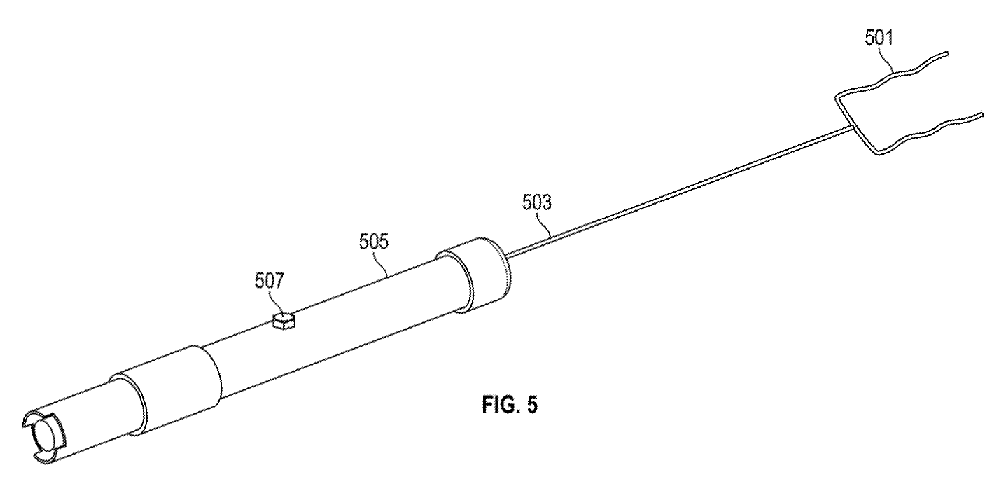

FIG. 5 shows an illustration of a rotisserie cooking apparatus, in accordance with an example embodiment. The apparatus includes a skewer (501) connected to a stainless steel rod (503), which is attached to a motor through the PVC pipe (505). The body of the pipe includes a push button (507) to start and stop the rotation of the skewer.

In one embodiment, the manufacture of the automatic rotisserie may include a number of steps including: Step 1: obtain the ⅛″ stainless reverse skewers. Step 2: spot weld the skewers to a stainless steel rod. Step 3: a 3/16″ hole is drilled in the 1.5″ diameter PVC cap, to accept the stainless steel rod. Step 4: obtain a 12″ piece of 1.5″ diameter PVC and include another support 8″ from the cap as the rod passes through this support to eliminate stress on the motor. Step 5: obtain a 1.5″ diameter PVC coupling, Step 6: the rod is inserted into a flexible coupling which is connected to the motor. Step 7: obtain a 5″ piece of 1.5″ diameter PVC containing the flexible mourned motor and a battery compartment for 3 AAA batteries controlled by a push button switch.

In one embodiment, the disclosure may be implemented as follows: The ⅛″ stainless steel skewers with five off-sets or waves on each of the two skewers prevent the hotdogs from spinning or falling off during the cooking process. In one embodiment, the skewers are welded to a 36″ stainless steel rod while pointed inward and toward the power source. In one embodiment, the 1.5″ diameter PVC cap with the 3/16″ hole is pressed onto the 12″ piece of PVC with the rod support 8 inches from the cap. The rod support also has a 3/16″ hole which is aligned with the hole in the cap so the rod will be perfectly aligned with the motor.

In one embodiment, the disclosure mare be further implemented using a 5″ piece of PVC that is machined to hold the motor on one side and machined on the other side to allow access to the battery compartment and to place and protect the push button switch. In one embodiment, the aluminum battery compartment and switch combo are pressed into the end opposite the motor and additionally secured with a sealing adhesive. In one embodiment, the motor wires are soldered to the wires on the battery compartment already in place. Furthermore, a 3″ piece of flexible tubing is attached to the motor shaft and held with a wire clamp. The motor may be placed into the machined slots and held temporarily in position with a small piece of glass tape. In one embodiment, the 1.5″ diameter PVC coupling is now pressed on the 5″ piece, on the motor side, to permanently hold the motor in place.

In one embodiment, the disclosure may be further implemented by sliding the assembled stainless steel skewer and rod through a 3/16″ hole in the PVC cap and the rod support. Further, the rod is then slid into a flexible coupling on the motor and held in place with a wire clamp. In one embodiment, the 12″ inch piece of PVC with the cap and rod assembly may be pressed into the 1.5″ diameter coupling, so that the rod and motor shaft are perfectly aligned to complete the assembly. In one embodiment, the apparatus may be powered with three AAA batteries and controlled by a push button switch in conjunction with a DC worm gear motor. In one embodiment, the motor may spin the rod at approximately 4 RPM's.

In one embodiment, the disclosure may be made using a motor with a targeted speed in revolutions per minute (RPM) as deemed appropriate. Furthermore, the components may also include a targeted DC voltage, torque, and output shaft length and diameter. In one embodiment, the motor may include mounting tabs to attach to the PBC housing. In one embodiment, the turbine worm gear box motor includes the specs of 3-12 volts DC, 16 RPM, a 5.2 mm total length, a 27 mm axis length, a 2.5 mm screw hole, and a 125 mm cable length. Further, the motor may be tested for reliability and also fit well into the PVC housing. In one embodiment, a power supply is required that adapts to the 1.5″ diameter PVC pipe to house the motor and battery/switch compartment.

In one embodiment, one side of the pipe is machined with two ¼″ diameter by ⅛″ deep half round slots for the motor mounting tabs to fit into. The other end of the pipe is machined with two ⅞″ wide by ½″ deep slots on opposite sides of the pipe. These slots allow the battery/switch compartment to slide, far enough, into the pipe to prevent the switch from dropping, but also allow the unscrewing of the compartment to change a battery. In one embodiment, a piece of PVC is cut to 1.5″ by 2.25″ long, then out length wise into 6 even pieces, approximately ¾″ wide. In one embodiment, the power supply is assembled by first holding the 1″×2.5″, with 3/16″ slot and cutting two pieces of PVC with the slot facing straight up. Then, two shims may be held on opposite sides of the slotted piece, which are 90 degrees from the slot, and then, 3 pieces are loosely clamped into a vice with 1″ of length protruding.

In one embodiment, the battery/switch compartment is slid with the switch end placed first into the 1″ slotted pipe until flush with the end sticking out of the vice. Then, the vice may be tightened until the 1″ pipe compresses tightly onto the battery/switch compartment. In one embodiment, the end of the 5″ piece of 1.5″ diameter PVC with the 7/18″ wide by ½″ deep slots are pressed with the 3 pieces by clamping in the vice. The vice may then be opened and the remaining length of the battery/switch compartment pressed, with shims, fully it to the 5″ piece 1/16″ past the end. In one embodiment, adhesive/sealer may be used to hold the components firmly in place and to seal the compartment. Then, the motor may be added by soldering the motor leads to the battery compartment and then securing the connections. In one embodiment, the motor is slid into the end of the 5″ long piece with the ¼″ diameter and ½″ deep half round slots.

In one embodiment, the motor is set into the slots, so the output shaft is closest to the PVC. Next, a 2.5″ by 0.5″ piece of glass tape is used to tape the motor to temporarily hold it into place. In one embodiment, a piece of flexible tubing 3″ long with 0.170″ I.D×¼ O.D. is cut and pressed into the motor shaft. The tubing may then be secured to the shaft with a wire clamp and a 1.5″ PVC coupling pressed into the motor end of the piece, which permanently holds the motor in place. In one embodiment, a 12″ piece of PVC may be cut and a hole drilled of 5/16″ and placed 8″ from either end of the pipe. Then, a hole is tapped with a ⅜″×16″ tap. Then, using a ⅜″ bolt that is 1″ long, drill a 3/16″ hole that is ½″ below the bolt head. The bolt may be threaded into the tapped hole as far as it will go, but while still allowing the hole to be aligned with the hole in the pipe.

In one embodiment, the bolt acts as a rod support to protect the motor from stress. In one embodiment, a 1.5″ PVC pipe cap may be drilled with a 3/16″ hole that is ½″ from the inside edge of the cap flange. in one embodiment, the cap may be pressed onto the 12″ piece and kept 8″ away from the ⅜″ bolt. The holes in the cap and bolt must line up exactly to accept the 3/16″ cooking rod. Then, a 12″ piece of ⅛″ stainless steel rod that is 12″ long may be used to make two 90 degree bends that are 4.5″ from each end to form a “U” shape. Next, each 4.5″ side may be put into a jig. A set of five offsets, waves, zigzags, corkscrews, or curves are added that are 5/16″ deep on each side. This shape ensures the food, such as a hot dog will be secured when rotating over an open fire.

In one embodiment, a 3 foot long piece of 3/16″ stainless steel rod may be spot welded into a “U” shape to make a roasting stick. Then, the roasting stick may be slid through the holes in the pipe cap, in the 12″ piece, and through the hole in the threaded bolt. Furthermore, the rod may be slid into the flexible coupling, which is already clamped to the motor and secured with a wire clamp. As a next step, the 12″ section may be pressed with the roasting rod into the 1½″ coupling already pressed on the 5″ motor and battery section. Thus, ensuring a proper alignment between the rod and motor shaft. Add three AAA batteries and the apparatus is may be used.

In one embodiment, the unit can be used as described, and as such, may be set by a fire and/or propped up on a rock or log. It is also envisioned that a removable clamp on the legs can be used on just the front or on both the front and back to allow the apparatus to function like a mini spit. Furthermore, adjustable legs and/or fold up legs may be permanently mounted.

In one embodiment, the stainless steel rod and skewers could be substituted with chrome plated steel to reduce the cost.

In another example embodiment, fold up legs could be added to simplify the desired cooking height at a reduced cost. Also, a detachable rod coupler could be added to make cleaning easier and to shorten the product for easier packaging and shipping.

In one embodiment, the skewers at the end of the 3/16″ rod can be attached and pointed toward the unit for added safest. In an example embodiment, the 5″ cut from the 3/16″ rod allows a proper ballast for the unit. Thus, the unit may be secured and the weight of the food, such as hot dogs will not teeter toward the hot coals or flames.

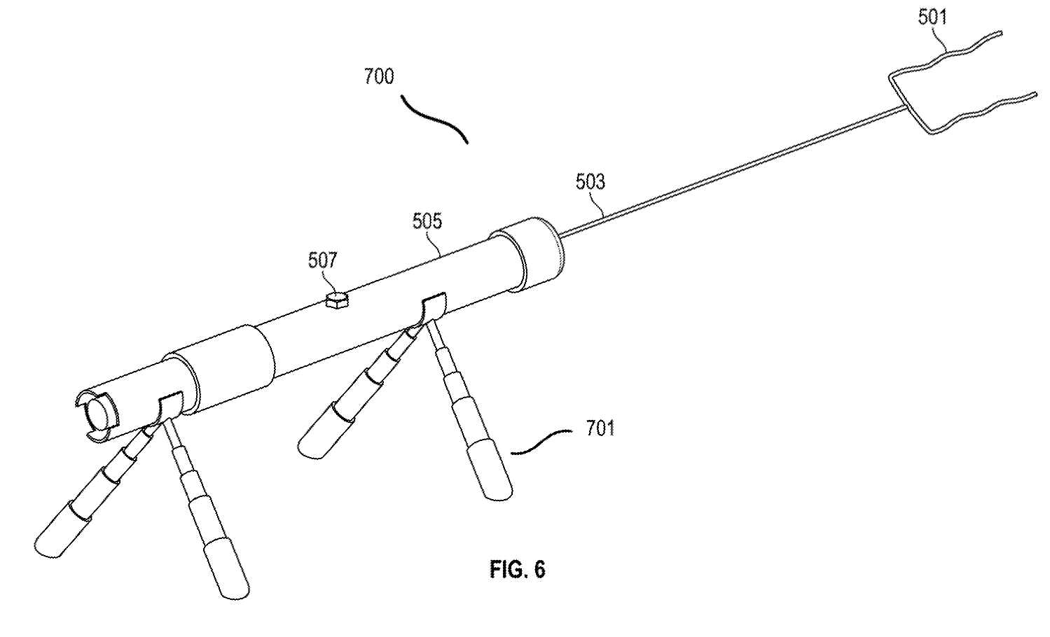

FIG. 6 shows a height adjustable rotisserie cooking apparatus 700, in accordance with an example embodiment. The height adjustable stands 701 are configured to be attached to the arm of the rotisserie. The arm 505 of the rotisserie may be extended or retracted while the apparatus is standing on the stands 507. Stand 701 and arm 505 are retractable for compact size and portability. The rotisserie cooking apparatus 700 is a self-contained standalone apparatus.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. An apparatus for holding and rotating food, the apparatus comprising:
a fork;
an extendible arm configured to removably attach the fork;
a motor configured to be coupled to the fork to rotate the fork; and
a height adjustable support for the arm.

2. The apparatus according to claim 1, wherein prongs of the fork are U shaped.

3. The apparatus according to claim 2, wherein distal ends of the prongs are bent backward.

4. The apparatus according to claim 3, wherein the prongs include wave or zig-zag portion.

5. The apparatus according to claim 3, wherein a lamp is attached to the arm and is configured to shine light to the prongs.

6. The apparatus according to claim 3, wherein a number of prongs in the fork is between 2-6.

7. The apparatus according to claim 3, wherein the rotation of the fork is automated and controlled by a button.

8. The apparatus according to claim 3, wherein the rotation of the fork can be remotely adjusted.

9. A portable apparatus for holding and rotating food, the apparatus comprising:
a fork;
an extendible arm configured to removably attach the fork;
a motor configured to be coupled to the fork to rotate the fork; and
a height adjustable support for the arm, wherein the height adjustable support is configured to be folded with the arm.

10. The apparatus according to claim 8, wherein the apparatus is standalone.
